(19) United States
(12) Patent Application Publication
(10) Pub. No.: US 2017/0270422 A1
(43) Pub. Date: Sep. 21, 2017

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Hideki Sorakado, Tokyo (JP)

(21) Appl. No.: 15/457,001

(22) Filed: Mar. 13, 2017

(30) Foreign Application Priority Data
Mar. 16, 2016 (JP) 2016-052638
Jan. 25, 2017 (JP) 2017-011253

(51) Int. Cl. G06N 7/00; G06N 99/00

(52) U.S. Cl. CPC G06N 7/005; G06N 99/005

(57) ABSTRACT

It is an object to attain both of a privacy protection and an elimination of a timing gap. The object is accomplished by providing: an estimating unit for estimating use possibility of a service for each user; a classifying unit for classifying a plurality of users into groups on the basis of a similarity between the use possibility and context information of the plurality of users according to the service; and a generating unit for generating disclosure information which is disclosed to a providing source side of the service for each group on the basis of the context information of the users included in the group.

### BACKGROUND OF THE INVENTION

### Field of the Invention

The present invention relates to an information processing apparatus, an information processing method, and a program.

### Description of the Related Art

In the related arts, a context of the user is estimated and information and services according to a situation are recommended. Such a system and a technique are called various names such as Personal Assistant, Context Aware Computing, and the like. In this instance, it is assumed that they are called Personal Context Assistant (hereinbelow, PCA). For example, as a PCA, topic news, prefectural news, and the like are provided based on commuting time or present position. There is also considered such a service that when an arrival at an airport or the like is detected based on position information, it is recommended that a taxi dispatch is requested or the like.

However, there is a case where even if the service is recommended and the user uses such a service, it takes a waiting time in dependence on the service. For example, in the case of the taxi dispatch, if the user requests the dispatch after he watched a notification, at the airport, it is necessary to wait until a taxi arrives.

As mentioned above, since a gap occurs between the timing when the user needs the service and the timing when the service provider can provide the service, a waiting time occurs.

Therefore, in order to solve such a timing gap, it is considered in future that the system prepares and executes the service in advance. For example, Japanese Patent Application Laid-Open No. 2008-524714 provides such a technique that by preliminarily shipping goods to a warehouse near the customer before he orders them, a reduction of a time required until the delivery after the ordering is realized, or the like.

In order to allow the system to prepare the service in advance, it is necessary to enable the service providing source to prepare. As a platform for this purpose, it is presumed that such a mechanism that a context is shared with the service providing source can be realized.

At this time, it is considered that if the context is unconditionally shared, the service providing source having such a will that the context is used by a purpose other than a fair purpose accumulates the context. In this instance, an action history of the user remains on the service providing side. Thus, privacy is not protected. However, if the context is not shared until timing just before a possibility of use of the service rises, the timing gap increases.

In the related arts, in order to protect privacy, there is an anonymization technique (for example, International Publication No. WO 13/031997). International Publication No. WO 13/031997 provides an anonymizing method whereby when individual data has k anonymization request levels, a reduction of an information value is prevented while satisfying the request levels of all of the data. More specifically speaking, according to the technique of International Publication No. WO 13/031997, in order to prevent the reduction of the information value, such a process that similar data is classified into groups and, when the request level is satisfied, the group is divided again is repeated. According to the technique of International Publication No. WO 13/031997, an anonymizing process is executed on a minimum group unit basis which satisfies the request level. By such a process, such an anonymization that the reduction of the information value is prevented while satisfying the request level which each data requires is performed.

If the context of the user is provided at a higher precision, the timing gap can be further decreased. Therefore, when a probability at which the service is used is high, the context of the user should be provided at a higher precision.

Therefore, in order to leave the context of the user of a high use probability at a higher precision, as a request level of anonymization in International Publication No. WO 13/031997, such a technique that the use probability is used for a service is considered. That is, such a technique that the higher the use probability of the service is, the more the request level of anonymization is reduced is considered.

However, according to International Publication No. WO 13/031997, the user in which the request level of anonymization is low and the user in which such a level is high are anonymized together. Therefore, such a situation that the request level of the user who wants to reduce the anonymization request level is matched with the request level of the user in which the anonymization request level is high can occur in dependence on circumstances. At this time, such a problem that a purpose of the user who wants to reduce the request level of anonymization to further progress a preparation of services is not accomplished occurs.

It is an aspect of the invention to attain both of a protection of privacy and an elimination of a timing gap.

### SUMMARY OF THE INVENTION

According to an aspect of the invention, there is provided an information processing apparatus comprising: an estimating unit configured to estimate use possibility of a service for each user; a classifying unit configured to classify a plurality of users into groups on the basis of a similarity between the use possibility and context information of the plurality of users according to the service; and a generating unit configured to generate disclosure information which is disclosed to a providing source side of the service for each of the groups on the basis of the context information of the users included in the group.

According to the invention, both of the protection of privacy and the elimination of the timing gap can be attained.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration of an information processing system.

FIG. 2 is a diagram illustrating an example of a hardware configuration of a computer.

FIG. 3 is a diagram illustrating an example of a function configuration of a PCA server.

FIGS. 4A, 4B, and 4C are diagrams illustrating an example of parameters and the like.

FIG. 5 is a flowchart illustrating an example of a disclosure information generating process.

FIG. 6 is a flowchart illustrating an example of an anonymization group generating process.

FIG. 7 is a flowchart illustrating an example of a limit error group dismantling process.

FIGS. 8A, 8B, and 8C are diagrams (part 1) illustrating an example of context information.

FIGS. 9A, 9B, and 9C are diagrams (part 2) illustrating an example of context information.

FIGS. 10A, 10B, and 10C are diagrams (part 3) illustrating an example of context information.

FIG. 11 is a diagram illustrating an example of parameters and the like.

FIGS. 12A and 12B are diagrams (part 4) illustrating an example of context information.

FIGS. 13A and 13B are diagrams (part 5) illustrating an example of context information.

FIGS. 14A, 14B, 14C, and 14D are diagrams (part 6) illustrating an example of context information.

### DESCRIPTION OF THE EMBODIMENTS

Preferred embodiments of the present invention will now be described in detail hereinbelow in accordance with the accompanying drawings.

### Embodiment 1

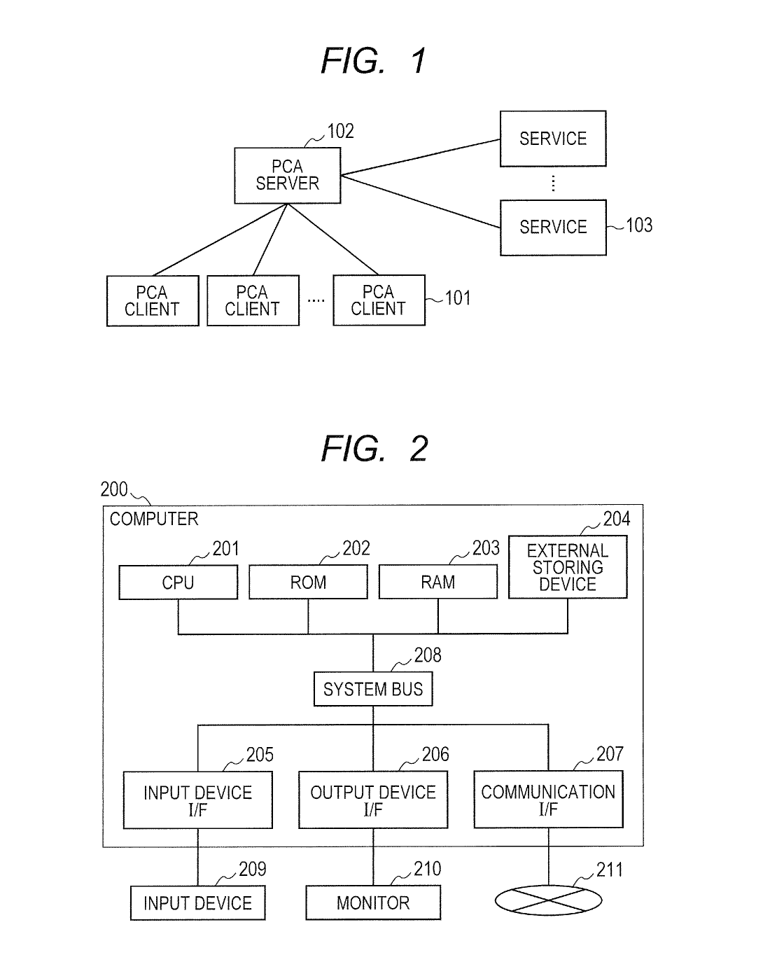

A system configuration of an information processing system of the embodiment will be described with reference to FIG. 1.

A PCA client 101 is a client, acquires context information, and transmits to a PCA server 102. The PCA client 101 is, for example, a mobile device such as a smart phone or the like which the user possesses. As context information, for example, there are: position information such as longitude, latitude, and the like acquired by a GPS (Global Positioning System); an angular velocity acquired by a gyro sensor; an azimuth acquired by a magnetic sensor; an acceleration acquired by an acceleration sensor; and the like. In addition, as context information, for example, there are: information of concentration or the like which is estimated from a vital such as a cardiac beat or the like of the user, an oscillation, or the like; information of a use situation or the like of a device; information regarding the device, object, and the like which exist near the user and are acquired by close communication or the like; and the like.

The PCA server 102 anonymizes the context information acquired from a plurality of PCA clients 101 and provides the context information to a plurality of services 103. The PCA server 102 is, for example, a server apparatus or the like. Or, the PCA server 102 may be, for example, a virtual server or the like constructed in a cloud environment.

The PCA server 102 may process the context information acquired from the PCA client 101 and generate context information of a higher order. The PCA server 102 may anonymize such context information of the high order and provide to the services 103.

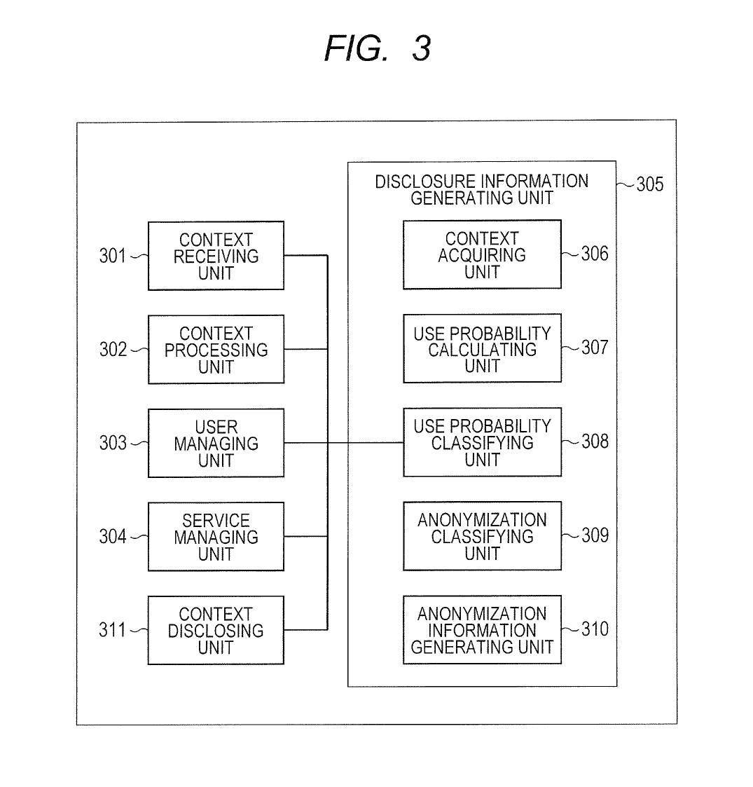

A generating process of the context information of the high order will be described in a description of a context processing unit 302 in FIG. 3.

The service 103 prepares a service according to the user on the basis of the anonymized context information. For example, if the service is a taxi service or the like, since position information or the like of the user is anonymized and acquired, such a process that a traveling route of the taxi is changed based on such information or the like is executed.

A configuration of a computer constructing the server apparatus and client apparatus of the embodiment will be described with reference to FIG. 2. Each of the server apparatus and client apparatus may be realized by a single computer or may be realized by distributing functions to a plurality of computers in accordance with necessity. If the system is constructed by a plurality of computers, they are connected by a local area network (LAN) or the like so that they can communicate with each other.

A CPU 201 is a central processing unit (CPU) for controlling a whole computer 200. A ROM 202 is a read only memory (ROM) for storing programs and parameters which do not need to be changed. A RAM 203 is a random access memory (RAM) for temporarily storing programs and data which are supplied from an external apparatus or the like. An external storing device 204 is a hard disk or a memory card fixedly provided in the computer 200. Or, the external storing device 204 may include a flexible disk (FD), an optical disk such as a compact disc (CD) or the like, a magnetic or optical card, an IC card, a memory card, or the like which is detachable from the computer 200. An input device interface (I/F) 205 is an interface with an input device 209 such as pointing device, keyboard, or the like which receives the operation of the user and inputs data. An output device interface (I/F) 206 is an interface with a monitor 210 for displaying data held in the computer 200 or supplied data. A communication interface (I/F) 207 is a network interface for connecting with a network line 211 such as Internet or the like. A system bus 208 is a system bus for connecting each of the units 201 to 207 so that they can communicate with each other.

The PCA client 101 as a client apparatus of the embodiment includes sensors and the like. For example, as sensors, there are a GPS sensor, a gyro sensor, a magnetic sensor, an acceleration sensor, and the like. It is also possible to construct in such a manner that the vital sensor for acquiring cardiac beats or the like has a form of another apparatus and the PCA client 101 acquires data from the communication interface or the like. If the PCA client 101 has a form such as a smart phone or the like, it includes a speech unit or the like and an imaging unit or the like.

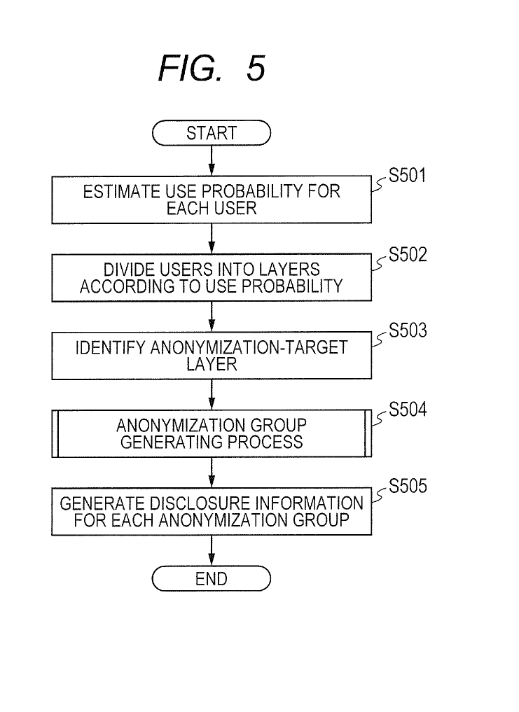

The CPU 201 of the server apparatus executes processes based on the program stored in the ROM 202 or the external storing device 204 of the server apparatus, so that functions of the server apparatus illustrated in FIG. 3, which will be described hereinlater, and processes of flowcharts of FIGS. 5 to 7 are realized.

In the embodiment, the PCA server 102 anonymizes the context information collected from the PCA client 101 and discloses information to the service 103. A function configuration of the system for generating information to be disclosed in the embodiment will be described hereinbelow with reference to FIG. 3. In the embodiment, it is assumed that the functions illustrated in FIG. 3 have been installed in the PCA server 102. However, it is also possible to construct in such a manner that a part of the functions may be distributed to the PCA client 101 and the like.

A context receiving unit 301 receives the context information from the PCA client 101. More specifically speaking, the context receiving unit 301 receives the context information such as position information or the like through the communication I/F 207.

A context processing unit 302 processes the context information and generates the context information of a high order.

For example, when a latitude and a longitude are acquired from the PCA client 101, the context processing unit 302 may convert the latitude and longitude into information such as an address or the like.

The context processing unit 302 may generate information regarding a relationship between ambient objects and persons. For example, the context processing unit 302 may estimate that the users who draw the same locus act together or the like from loci of the position information acquired from a plurality of users and generate information of companions. Or, the context processing unit 302 may identify the object acquired by close communication and identify that the user possesses the object, or the like. For example, the context processing unit 302 may identify a carrying or the like of a smart watch or the like.

Or, the context processing unit 302 may generate information regarding a physical state. For example, the context processing unit 302 may estimate that the user is walking, is driving a car, or the like from the position information, acceleration information acquired from the acceleration sensor, or the like and generate information regarding the physical state. Or, the context processing unit 302 may estimate a fatigue degree or the like from a continuation time or the like of a walking state and generate information regarding the physical state.

Or, the context processing unit 302 may generate information regarding a mental state. For example, the context processing unit 302 may estimate that although the user exists in an environment such as a workplace where he should concentrate his attention, since a concentration degree is low, he considers that he wants to concentrate or the like, and may generate information regarding the mental state. Or, a taste or the like may be used as a mental state. For example, the context processing unit 302 generates information or the like of goods which the user desires from a past history of a willingness to buy or the like. Or, the context processing unit 302 may generate information or the like of desired goods of the user on the basis of “list of goods which the user wants” or the like which has previously been input. In the embodiment, as context information, in addition to information showing a situation such as when, where, what, whom, or the like, information showing a relationship between the user and the person/object, a physical state of the user, or the like may be used.

The functions of the context processing unit 302 may be realized by distributing them to the PCA clients 101 and the PCA server 102.

A user managing unit 303 manages the user information and the context information of the user. More specifically speaking, the user managing unit 303 holds the context information acquired by the context receiving unit 301 and the context processing unit 302 into the external storing device 204 and manages.

A service managing unit 304 manages the services which disclose the user information. More specifically speaking, the service managing unit 304 holds the list regarding the information of the services into the external storing device 204 and manages.

A disclosure information generating unit 305 generates context information which is disclosed to the services. More specifically speaking, a processing method is as follows. First, the disclosure information generating unit 305 estimates a use probability (use possibility) of the service of the user and classifies the users into layers for each use probability. Subsequently, the disclosure information generating unit 305 classifies the users into groups for each layer on the basis of information to be anonymized. By executing the anonymizing process for each group, the disclosure information generating unit 305 generates the context information to be disclosed. Detailed processing contents will be described hereinlater with reference to the flowchart of FIG. 5.

The disclosure information generating unit 305 is constructed by a context acquiring unit 306, a use probability calculating unit 307, a use probability classifying unit 308, an anonymization classifying unit 309, and an anonymization information generating unit 310.

The context acquiring unit 306 acquires the context information of the user before executing the anonymization. More specifically speaking, the context acquiring unit 306 searches for the context information of the user from the user managing unit 303 and acquires it.

The use probability calculating unit 307 calculates a use probability of the service for each user. More specifically speaking, the use probability calculating unit 307 estimates a use probability of the service for each service managed by the service managing unit 304. For example, if the service is a taxi service or the like, the use probability calculating unit 307 estimates a probability at which a dispatch of the taxi is requested. More specifically speaking, the use probability calculating unit 307 learns a situation in which the user gets on a taxi from a habitual action and calculates a probability at which the user arrives at such a situation from the current situation. For example, it is assumed that after the user did shopping in a shopping mall, when it's raining in the outside, a probability at which the user calls a taxi is high. For example, the use probability calculating unit 307 can identify that the user exists in the shopping mall from the position information or the like, and can calculate the probability at which the user calls the taxi from a probability of rainfall or the like of the weather in the outside. However, a calculating method of the use probability is not limited to them.

The use probability classifying unit 308 classifies the use probabilities of the users acquired by the use probability calculating unit 307 for each user whose use probabilities are almost equal. In the embodiment, such a classification is called a layer. For example, an interval of the use probabilities which are almost equal is preliminarily obtained for each service and the use probability classifying unit 308 uses such an interval. The use probability classifying unit 308 may acquire such a use probability interval or the like from the service 103 and use it.

The anonymization classifying unit 309 classifies the users into groups on the basis of the similarity of the context information as a target of the anonymization for each layer acquired by the use probability classifying unit 308. At this time, as for a size of group, the anonymization classifying unit 309 uses a predetermined value for each layer. Or, the anonymization classifying unit 309 determines the group size on the basis of the use probability. A detailed determining method of the group size will be mentioned after a description of the flowcharts of FIGS. 5 to 7.

As for the similarity of the context information, if the context information is a numerical value such as “age” or the like, a reciprocal number or the like of a difference between the numerical values can be used as a similarity. If the context information is a vector such as “position information” or the like, a reciprocal number or the like of a distance between the vectors can be used as a similarity. Or, a cosine similarity degree or the like may be used. If the context information is categorical data such as “sex” or the like, the similarity degree can be defined by a discrimination result about whether or not the data coincides.

There is also a case where the context information is categorical data having a layer. At this time, by using information showing to which number of designated layer the data coincides, the layer number of the layer in which the data coincides may be used as a similarity. Or, the number of times of movement which is necessary when moving from one data to another data by tracing a tree of layers is used as a distance between the data and the similarity degree may be defined by a reciprocal number or the like of the distance.

If the context information is constructed by a plurality of vectors, categorical data, or the like, the vector data is converted into categorical data and the similarity degree of the data may be determined from the number of times of coincidence of the categorical data or the like. Or, a similarity degree is acquired for each data constructing the context information and a sum of weights of the similarity degrees or the like may be used. A defining method of the similarity of the context information in the embodiment is not limited to them.

As a classifying method of the users based on the context information, the users may be classified by a clustering method such as k-means, spectral clustering, or the like on the basis of the similarity of the context information. Or, a method whereby a generalization layer tree which is often used in the k-anonymizing method is used may be used. The classifying method of the users in the embodiment is not limited to them.

The anonymization information generating unit 310 generates the context information to be disclosed for each group acquired by the anonymization classifying unit 309. For example, if the context information to be disclosed is position information, the anonymization information generating unit 310 acquires centers of gravity or the like of the position information of the users constituting the group. In addition, the anonymization information generating unit 310 may acquire a maximum distance, as a radius or the like, from the center of gravity to the users constituting the group and use it as information to be disclosed. If the context information to be disclosed is an attribute value such as an address or the like, the anonymization information generating unit 310 performs such a generalization that the address is omitted or the like. However, a generating method of the anonymization information is not limited to them.

A context disclosing unit 311 discloses the context information generated by the anonymization information generating unit 310 to the service. For example, in the case where the position information is anonymized and disclosed, since the center of gravity and the radius have been acquired by the anonymization information generating unit 310, the context disclosing unit 311 discloses them in association with a user ID. Or, the context disclosing unit 311 may disclose the information on a group unit basis or may allocate an ID to the group generated by the anonymization classifying unit 309 and disclose the information by associating the group ID with the center of gravity, the radius, and the user ID list. However, a disclosing method of the context information is not limited to them.

It is desirable that the user ID to be associated is closed to the service. It is also desirable that the user ID in the PCA server is not used. This is because, in the embodiment, the context information is generated such that the number of users cannot be narrowed down to be equal to or less than a certain number or more from the disclosed context information. However, if an ID which can uniquely identify the user in the whole PCA is used, identifying performance occurs. On the other hand, in the case of the ID closed to the service, in order to associate with the context information which is not disclosed to the service, the user ID of the service cannot be used. Therefore, the data is coupled by making a coincidence of the context information. However, since the context information has been anonymized, the number of users cannot be narrowed down to a value which is equal to or larger than the predetermined number. Thus, the information of an amount which is equal to or larger than a value which is presumed by the user is not disclosed.

The user ID in the PCA server may be used. At this time, even the context information which is not disclosed to the service can be easily coupled by using the user ID. However, since a precision of the context information which is disclosed deteriorates in the anonymization step, its privacy can be protected to a certain extent.

There is no need to include the user ID in the information which is disclosed and only the context information may be disclosed. However, a construction of the information which is disclosed is not limited to them.

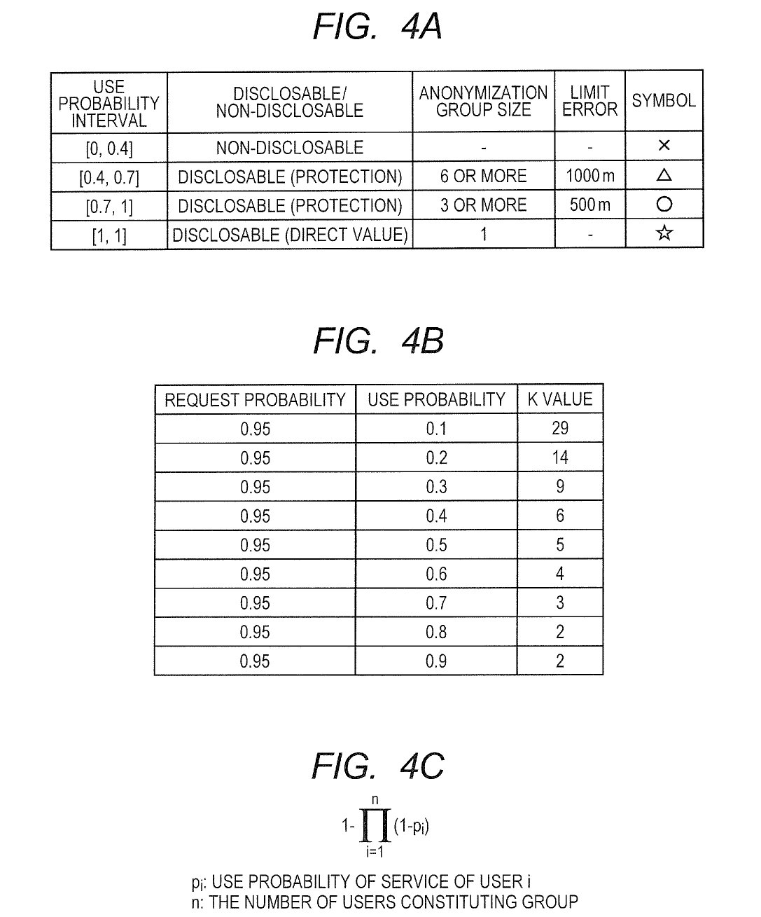

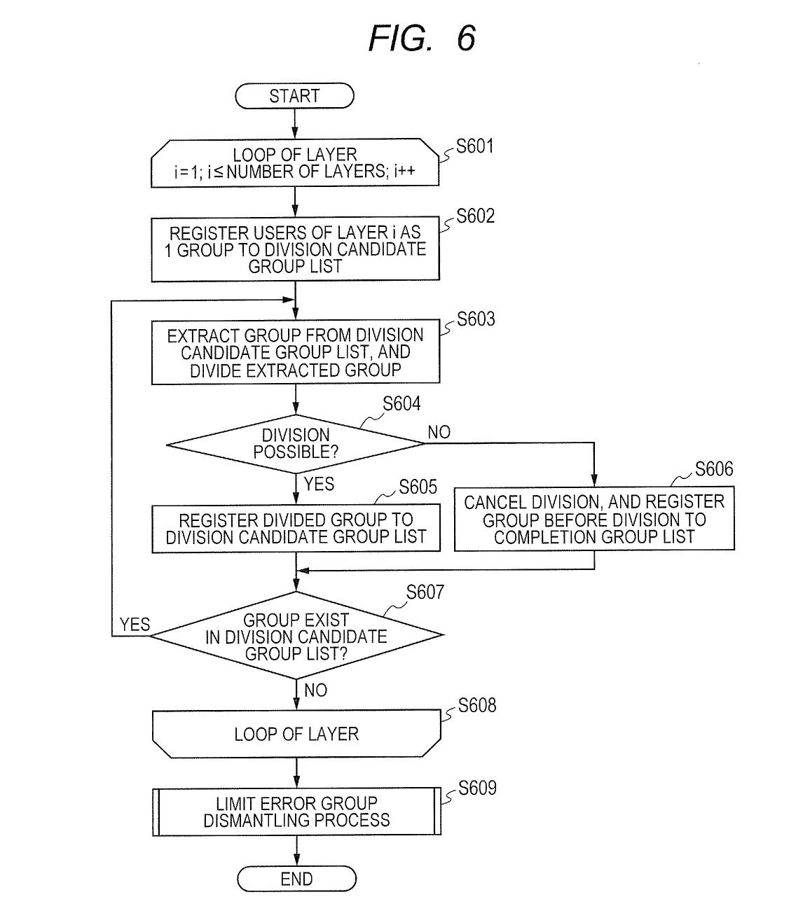

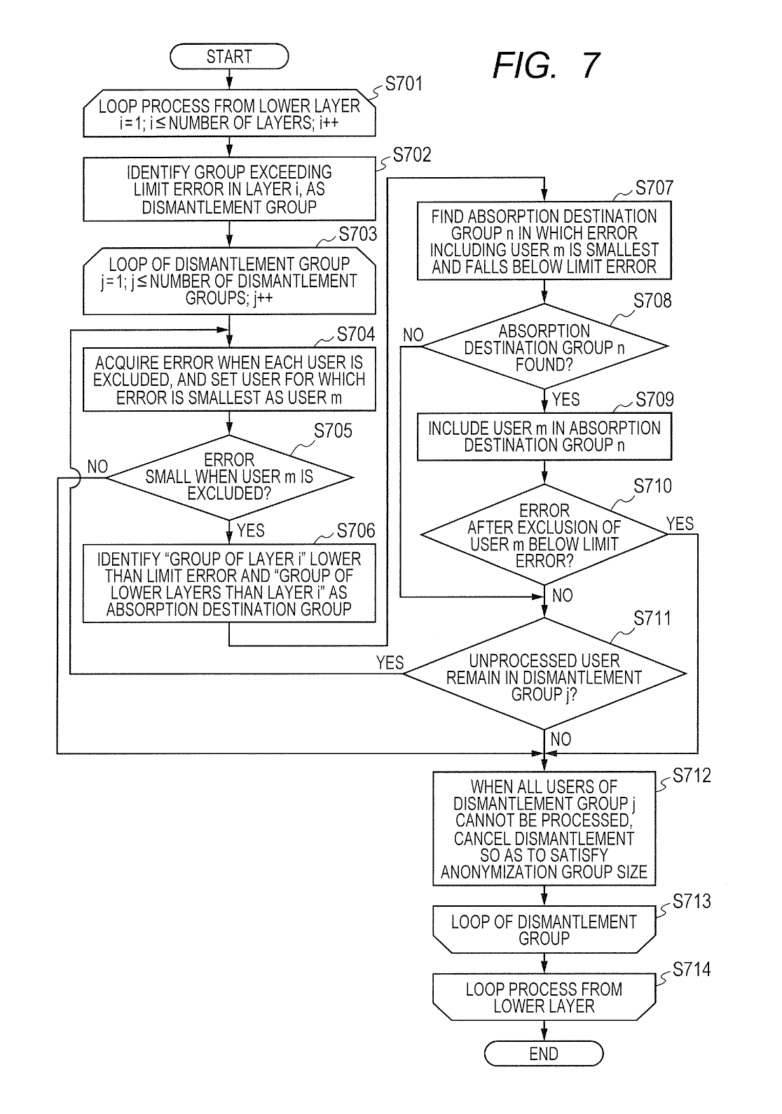

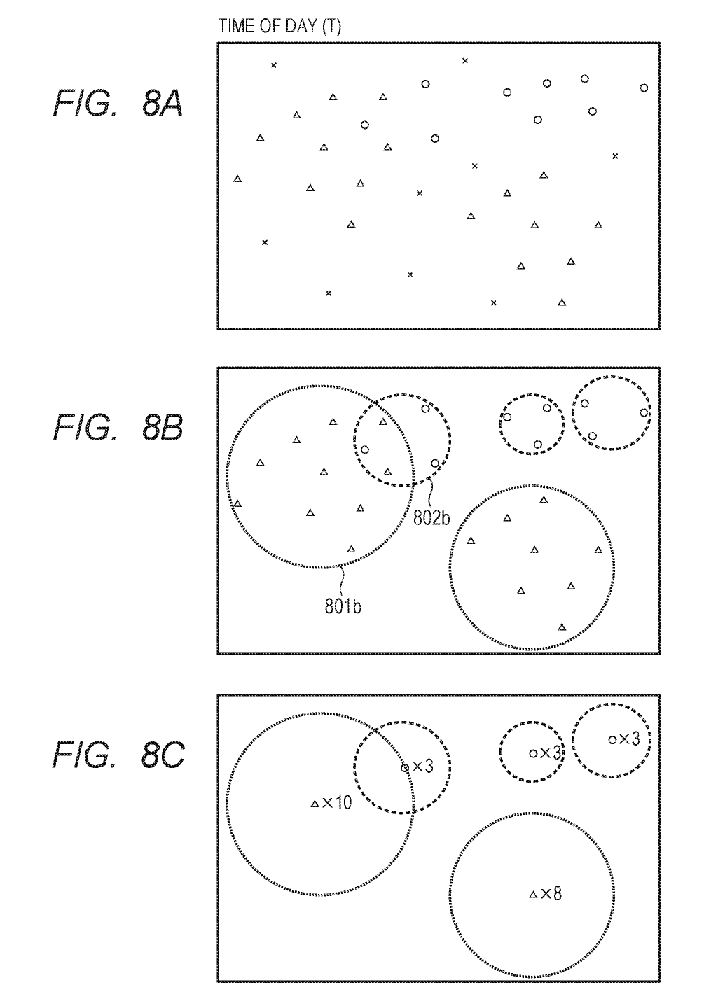

Subsequently, a disclosure information generating process in the embodiment will be described with reference to the flowchart of FIG. 5. The present process is executed by the disclosure information generating unit 305 and generates the context information which is disclosed to the service. For this purpose, in the process, the service is designated as a parameter and the process is executed. In addition, the set parameter is also allocated for each service and the process is executed. The parameters will be described with reference to FIG. 4A. The first parameter is an interval between the use probabilities which are used when the users are classified into layers. In this example, the intervals adapted to classify the users into four layers have been predetermined. The second parameter defines disclosable/non-disclosable of the context information for each layer. Here, “non-disclosable” indicates that the information is not disclosed. Further, “disclosable (protection)” indicates that after the information was anonymized, it is disclosed. Furthermore, “disclosable (direct value)” indicates that the information may be disclosed without anonymizing it. The third parameter is an anonymization group size and designates a size of anonymization group which is generated in the layer. A limit error of the fourth parameter designates an error which should be set to a limit of the anonymization information which is generated in the layer. Details will be described with reference to the flowchart of FIG. 6. The limit error is an example of a set error. Here, “symbol” is a symbol which is used in the description in the embodiment and is not a parameter.

In the following description, a case of anonymizing the position information will be described as an example. An explanation will be made hereinbelow with reference to the flowchart of FIG. 5.

In S501, the use probability calculating unit 307 estimates the use probability of the service for each user. More specifically speaking, the use probability calculating unit 307 estimates the probability at which the user uses the service for each user by using the use probability calculating unit 307.

In S502, the use probability classifying unit 308 classifies the users into layers on the basis of the use probabilities. More specifically speaking, by using the interval of the use probabilities illustrated in FIG. 4A, the use probability classifying unit 308 determines to which use probability interval the user belongs.

In S503, the use probability classifying unit 308 identifies the anonymization-target layer. More specifically speaking, the use probability classifying unit 308 identifies the layer of “disclosable (protection)” with reference to disclosable/non-disclosable illustrated in FIG. 4A.

In S504, the anonymization classifying unit 309 executes the anonymization group generating process to the layer, as a target, identified in S503. Details will be described with reference to the flowchart of FIG. 6.

In S505, the anonymization information generating unit 310 generates the disclosure information for each anonymization group. For example, if the context information which is disclosed is the position information, the anonymization information generating unit 310 uses, as disclosure information, the centers of gravity and the radii of the position information of the users constituting the group.

With respect to the user information of the layers which are not used as an anonymization target in S503, the anonymization information generating unit 310 determines a disclosing method on the basis of the parameter of disclosable/non-disclosable. More specifically speaking, the anonymization information generating unit 310 does not disclose the information with respect to the user of the layer of “non-disclosable”. On the other hand, with respect to the user of “disclosable (direct value)”, the anonymization information generating unit 310 discloses the information as it is.

That is, the anonymization information generating unit 310 changes an intensity of the anonymization of the disclosure information on the basis of the use probability of the group, which will be described hereinafter. More specifically speaking, the higher the use probability of the group is, the anonymization information generating unit 310 weakens the anonymization of the disclosure information (for example, the disclosure information is held as a direct value as it is), and the lower the use probability of the group is, the anonymization information generating unit 310 enhances the anonymization of the disclosure information (for example, the disclosure information is not disclosed).

Subsequently, the anonymization group generating process in the embodiment will be described with reference to the flowchart of FIG. 6. In the present process, the anonymization group is generated by repeating a division of a user set for each anonymization-target layer. Such a process will be described hereinbelow every step. In S601, it is assumed that the anonymization classifying unit 309 is a loop for sequentially processing the anonymization-target layers identified in S503 in FIG. 5 and numbers have been allocated to the anonymization-target layers in order from 1. In order to refer to the layer by using a variable i, first, the anonymization classifying unit 309 initializes i to 1. Further, when i is equal to or less than the number of layers, the anonymization classifying unit 309 advances to S602. If such a condition is not satisfied, the processing routine drops out of the loop and advances to S609.

In S602, the anonymization classifying unit 309 registers the users of the layer i, as one group, to a division candidate group list.

In S603, the anonymization classifying unit 309 extracts the group from the division candidate group list and divides the extracted group on the basis of a similarity of the context information. The anonymization classifying unit 309 deletes the extracted group from the division candidate group list. As a dividing method, the anonymization classifying unit 309 divides the group into two groups by using a division clustering method such as k-means or the like. Or, the anonymization classifying unit 309 may divide the group by using a method such as spectral clustering or the like. The dividing method is not limited to them.

In S604, the anonymization classifying unit 309 evaluates a result of the division in S603 and discriminates whether or not the division is possible. More specifically speaking, the anonymization classifying unit 309 confirms that the size of group after the division satisfies the condition of the anonymization group size given as a parameter. For instance, in the example illustrated in FIG. 4A, such a condition that when the use probability interval is equal to or larger than 0.4 and is less than 0.7, the anonymization group size is equal to “6 or more” is set. When the size of group after the division satisfies the condition in each group after the division, the anonymization classifying unit 309 determines that the division is possible (OK), and advances to S605. In other cases, the anonymization classifying unit 309 advances to S606.

In S605, the anonymization classifying unit 309 registers the divided group to the division candidate group list.

In S606, the anonymization classifying unit 309 cancels the division in S603 and registers the group before the division to a completion group list.

In S607, the anonymization classifying unit 309 discriminates whether or not the group exists in the division candidate group list. If the group exists, the anonymization classifying unit 309 advances to S603. In other cases, the anonymization classifying unit 309 advances to S608.

S608 is an end of the loop of the layer and the anonymization classifying unit 309 adds 1 to i and returns to S601.

In S609, the anonymization classifying unit 309 executes a limit error group dismantling process. Details will be described with reference to the flowchart of FIG. 7.

Subsequently, the limit error group dismantling process in the embodiment will be described with reference to the flowchart of FIG. 7. At a start point of time of the present process, at timing just before S609 of the anonymization group generating process (FIG. 6), the system is in a state where the anonymization group has been registered to the completion group list. In the process, such a process that errors of the groups in the list are evaluated and the group having the large error is dismantled and coupled to another group, thereby reducing the error is tried. The limit error of the parameter is used in the evaluation of the error. As illustrated in FIG. 4A, the limit error is a value set for each layer.

S701 is a loop for sequentially processing the layers from the lower layer. The layer in which the use probability interval is small is called a lower layer. For example, in FIG. 4A, since the use probability interval of the second row is smaller than that of the third row, the second row is positioned to the lower layer. It is assumed that the numbers have sequentially been allocated to the layers from 1 in order from the lower layer. Since the anonymization classifying unit 309 refers to the layers by using the variable i, first, it initializes i to 1. Further, when i is equal to or less than the number of layers, the anonymization classifying unit 309 advances to S702. If such a condition is not satisfied, the processing routine drops out of the loop and ends.

In S702, the anonymization classifying unit 309 identifies the group exceeding the limit error in the layer i, as a dismantlement group. It is defined in such a manner that when describing in the example of FIG. 4A, for example, when the layer i is a layer in which the use probability interval is equal to or larger than 0.4 and is less than 0.7, the limit error is equal to 1000 m. Therefore, in this instance, the anonymization classifying unit 309 uses a radius of the group as an error and uses the group in which such a radius exceeds 1000 m, as a dismantlement candidate.

S703 is a loop for sequentially processing the dismantlement groups identified in S702. It is assumed that the numbers have sequentially been allocated to the dismantlement groups from 1. Since the anonymization classifying unit 309 refers to the dismantlement groups by using a variable j, first, it initializes j to 1. Further, when the dismantlement group j is equal to or less than the number of groups, the anonymization classifying unit 309 advances to S704. If such a condition is not satisfied, the processing routine drops out of the loop and advances to S714.

In S704, the anonymization classifying unit 309 acquires the error for each user at the time when the user is excluded from the dismantlement group. The anonymization classifying unit 309 sets the user for which the error is smallest to the user m. At this time, the anonymization classifying unit 309 sets a flag by assuming that the user m has already been processed. In addition, it is assumed that when the anonymization classifying unit 309 selects the user m, it selects the user m from the unprocessed users.

In S705, the anonymization classifying unit 309 discriminates whether or not if the user m is excluded, the error of the dismantlement group decreases. In addition, the anonymization classifying unit 309 discriminates whether or not if the user m is excluded, a condition of the anonymization group size is satisfied. When the condition is also satisfied (YES) while decreasing the error, the anonymization classifying unit 309 advances to S706. In other cases (NO), the processing routine advances to S712.

In S706, the anonymization classifying unit 309 identifies the “group of layer i” lower than the limit error and the “group of layers lower than layer i”, as absorption destination groups. A reason why the upper layers of the layer i are not included is that since the anonymization group size which is desired by the user of the layer i is larger than those of the upper layers, if the layer i is united to the upper layer side, the condition of the user of the layer i cannot be satisfied. On the other hand, since it is certain that the lower layers are larger than the size of anonymization group of the user of the layer i, the layer i can be united to the group of the lower layer side.

In S707, the anonymization classifying unit 309 acquires an error at the time when the user m is included in the absorption destination groups identified in S706. When the smallest error is lower than the limit error, the anonymization classifying unit 309 sets it to an absorption destination group n.

In S708, the anonymization classifying unit 309 discriminates whether or not the absorption destination group n has been found in S707. If it has been found (YES), the anonymization classifying unit 309 advances to S709. In other cases (NO), the anonymization classifying unit 309 advances to S711.

In S709, the anonymization classifying unit 309 includes the user m into the absorption destination group n.

In S710, the anonymization classifying unit 309 discriminates whether or not the error at the time when the user m has been excluded from the dismantlement group falls below the limit error.

When it is lower than the limit error (YES), the anonymization classifying unit 309 advances to S712. In other cases (NO), the anonymization classifying unit 309 advances to S711.

In S711, the anonymization classifying unit 309 discriminates whether or not an unprocessed user remains in the dismantlement group j. As a processed flag, the anonymization classifying unit 309 uses the flag allocated in S704. If there is an unprocessed user (YES), the anonymization classifying unit 309 advances to S704. In other cases (NO), the anonymization classifying unit 309 advances to S712.

In S712, when all of the users of the dismantlement group j cannot be processed, the anonymization classifying unit 309 cancels the dismantlement so as to satisfy the anonymization group size. More specifically speaking, the anonymization classifying unit 309 moves the user of the dismantlement group to another group which satisfies the limit error by the processes of S704 to S711. However, there is a possibility that the user remains in the dismantlement group. For example, when other groups which can satisfy the limit error do not exist, the user remains in the dismantlement group. At this time, if the user remaining in the dismantlement group does not satisfy the condition of the anonymization group size, the anonymization of the dismantlement group cannot be attained. Therefore, in such a case, the anonymization classifying unit 309 abandons that the limit error of the dismantlement group is decreased, and returns the process to a state where the condition of the anonymization group size is satisfied. More specifically speaking, in S709, the anonymization classifying unit 309 stores information showing that the user m is included in the absorption destination group n into a stack. In S712, the anonymization classifying unit 309 reads out information showing into which group the user has been included from the stack, and sequentially returns the users into the dismantlement group. The anonymization classifying unit 309 sequentially returns the users into the group until the dismantlement group satisfies the condition of the anonymization group size. Thus, the condition of the anonymization group size designated by the parameter can be satisfied, and anonymization performance of the group can be preferentially protected.

S713 is an end of the dismantlement destination group loop, and the anonymization classifying unit 309 adds 1 to j and returns to S703.

S714 is a loop process from the lower layer, and the anonymization classifying unit 309 adds 1 to i and returns to S701.

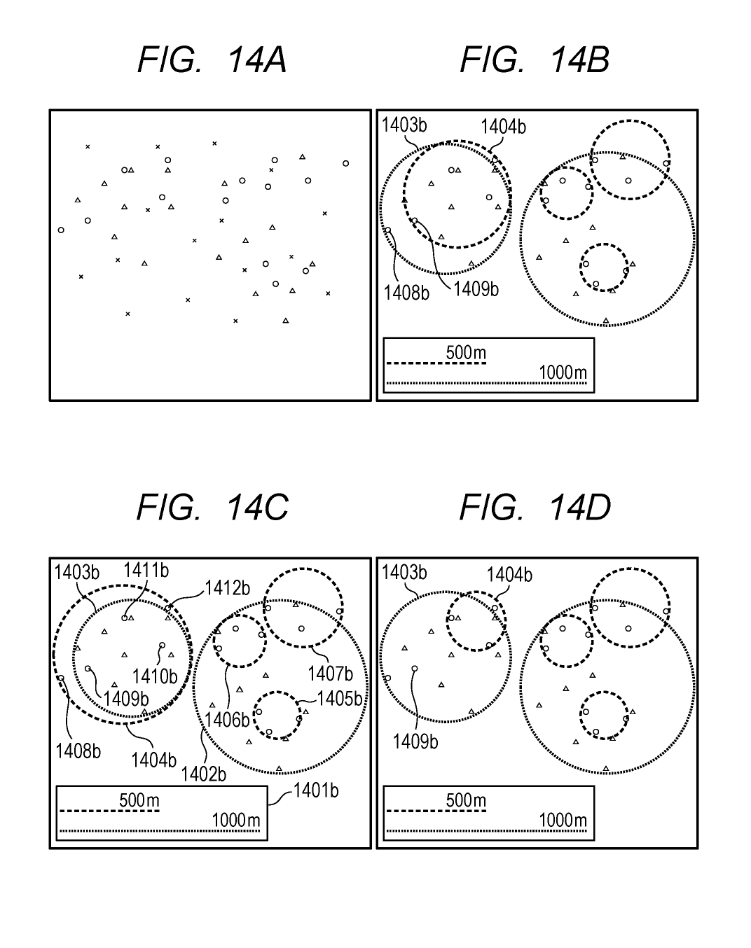

The foregoing processes of the flowchart of FIG. 7 will be specifically described with reference to FIGS. 14A to 14D with respect to a case, as an example, where the position information is anonymized and disclosed. FIG. 14A is a diagram illustrating distribution of the position information of the users. In the diagrams, ∘, Δ, and × denote use probabilities of the services of the users. A correspondence to the use probabilities is as illustrated in symbols in FIG. 4A.

FIG. 14A is a diagram illustrating distribution of the position information of the users. In the diagrams, ∘, Δ, and × denote use probabilities of the services of the users. A correspondence to the use probabilities is as illustrated in the symbols in FIG. 4A. A state illustrated in FIG. 14A illustrates a state after completion of S501 of the disclosure information generating process (FIG. 5).

FIG. 14B illustrates a state where the process is further progressed and the processing routine advances to timing just before the limit error group dismantling process (S609) is executed. Two kinds of broken lines indicate anonymization groups. An anonymization group shown by a fine broken line 1402b is an anonymization group of the layer in which a use probability is shown by Δ. An anonymization group shown by a coarse broken line 1404b is an anonymization group of the layer in which a use probability is shown by ∘. Since the layer in which a use probability is shown by × does not disclose information, it is deleted from the diagram. A limit error 1401b of each group which is used in a subsequent description is illustrated.

Processes of the flowchart of FIG. 7 will be specifically described hereinbelow on the assumption that the information illustrated in FIG. 14B has been input to the limit error group dismantling process. First, in S701, the layer of the use probability Δ is selected. In S702, the groups exceeding the limit error are identified. However, in this example, since the groups of the layer of the use probability Δ are lower than the limit error, S703 to S713 are skipped. In S714, the next layer of the use probability ∘ is set to a processing target and the processing routine is returned to S701.

Although four groups 1404b to 1407b exist in the next layer of the use probability ∘, only the group 1404b exceeding the limit error is selected in S702. In S703 to S713, by moving the users from such a group to another group, an error of the group 1404b is reduced. Five users 1408b to 1412b exist in the group 1404b. In S704, the user for which the error is smallest when each user is excluded from the group is selected. In this example, the user 1407b is selected. In this example, if the user 1407b is excluded, the error of the group 1404b decreases (S705). In S706, the groups 1402b to 1403b and 1405b to 1407b are identified as candidates of the absorption destination groups. In S707, the group in which the error is smallest and the limit error is also lower when the user 1407b is included is selected. In this example, it is determined that the user 1408b can be included in the group 1403b (S708). The user 1408b is moved from the group 1404b to the group 1403b and both errors are corrected (S709). Thus, the system enters a state of the anonymization group as illustrated in FIG. 14C. It will be understood that the group 1404b has been corrected so as to decrease the error and the group 1403b has been corrected so as to increase the error.

In S710, even if the user 1408b is moved, since the error of the group 1404b exceeds the limit error of 500 m, it is determined in S710 that a discrimination result is NO. In S711, since four unprocessed users still exist, it is determined in S711 that a discrimination result is YES.

In S704 to S708, similar processes are repeated again. That is, the user 1409b is identified as a user for which the error decreases when he is excluded. The group 1403b is identified as a group in which the error does not exceed the limit error even when the user 1409b is moved. In S709, the user 1409b is moved from the group 1404b to the group 1403b and the errors of both groups are updated. Thus, the system enters a state of the anonymization group as illustrated in FIG. 14D. The error of the group 1404b is small. On the other hand, since the group 1403b does not exert an influence on the error, the error does not change.

In S710, since the error of the group 1404b falls below the limit error of 500 m, it is determined in S710 that a discrimination result is YES. In S712, although all users cannot be processed yet in the group 1404b, since the anonymization group size is satisfied, such a situation that the dismantlement is cancelled does not occur. Since the groups other than the group 1404b do not exist as dismantlement candidates, the processing routine drops out of S713. Further, since the layers upper than the use probability ∘ do not exist, the processing routine also similarly drops out of S714 and ends.

In the foregoing processes, it is also possible to construct in such a manner that when the users of the dismantlement group are moved to the absorption destination group of the lower layers, the error of the absorption destination group satisfies the limit error of the upper layers. Specifically speaking, in S707, an error at the time when the user m belonging to the dismantlement group is included in the group of the lower layers is acquired, and the group in which such an error falls below the “limit error of upper layers” is acquired as an absorption destination group n. Thus, a deterioration of information quality of the disclosure information of the user moved from the upper layer to the group of the lower layers can be prevented.

As mentioned above, in the flowchart of FIG. 7, when there are groups exceeding the limit error, the user is moved to the group having an extra error. Thus, the group can be adjusted so as to satisfy the limit error.

It is desirable that the anonymization group size (FIG. 4A) as a parameter which is used in the foregoing disclosure information generating process (FIG. 5) is determined in consideration of the use probabilities of the services of the users constituting the group.

For example, a probability at which any one of the users constituting the group executes the service is defined as “use probability of the group”. It is also possible to set in such a manner that the use probability of the group is equal to or larger than a predetermined request probability. A probability at which any one of the users constituting the group uses the service can be acquired by an expression shown in FIG. 4C. FIG. 4B is a table illustrating information showing whether or not, when the request probability is set to 95%, the request probability of 95% or more can be accomplished if how many users belong to the anonymization group to the probability at which the services of the users are used. After the use probability interval of the layer was decided, the anonymization classifying unit 309 can determine the anonymization group size on the basis of the information as illustrated in FIG. 4B. For example, to the use probability interval which is equal to or larger than 0.4 and is less than 0.7, the anonymization classifying unit 309 uses the size of the largest anonymization group with reference to the interval which is equal to or larger than 0.4 and is less than 0.7 in FIG. 4B. Since the K value is equal to 6 in this example, the anonymization group size is set so as to be equal to 6 or more. By setting such a size by the anonymization classifying unit 309, the probability at which any one of the users of the anonymization group uses the service can be set to a value which is equal to or larger than the request probability of 95%.

Thus, even if the service made a preparation in accordance with the anonymized information, there is a possibility that at least one of the users receives the service at the request probability, and such an anonymization that the information which is effective to the service providing side is generated can be performed.

Or the anonymization classifying unit 309 may approximate the use probability of the group by a sum of the use probabilities of the users constituting the group. Thus, the use probability of the group can be acquired by a simple calculation.

The anonymization classifying unit 309 may acquire the foregoing request probability from the service. The anonymization classifying unit 309 may set the use probability of the group to a probability at which at least N users in the group use or the like instead of the probability at which one of the users in the group uses.

In the embodiment, the anonymization classifying unit 309 decides the anonymization group size as a parameter and, thereafter, executes the process. However, the anonymization classifying unit 309 may decide only the request probability and subsequently execute the process without deciding the anonymization group size. More specifically speaking, at the time of the discrimination in S604 in FIG. 6, by using the users constituting the group after the division and by using the expression shown in FIG. 4C, the anonymization classifying unit 309 calculates a probability (use probability of the group) at which at least one user uses the service. In each group after the division, when the use probability of the group exceeds the request probability, the anonymization classifying unit 309 determines that the division can be performed. On the other hand, when the use probability falls below the request probability, the anonymization classifying unit 309 determines that the division is impossible.

Also in the limit error group dismantling process (FIG. 7), although the anonymization classifying unit 309 cancels the dismantlement so as to satisfy the condition of the anonymization group size in S712, the anonymization classifying unit 309 cancels the dismantlement until the request probability is satisfied.

Consequently, whether or not the anonymization group satisfies the request probability at a higher precision than that in the case where the anonymization group size has preliminarily been decided. On the other hand, when the anonymization group size has been predetermined, since the process in S604 becomes easy, such an effect that the process can be executed at a higher speed is obtained.

Subsequently, an example in which position information is disclosed for the taxi service will be described with reference to FIGS. 8A to 10C.

FIG. 8A is a diagram illustrating a distribution of the position information of the users at certain time of day (T). In the diagrams, ∘, Δ, and × denote use probabilities of the taxi services of the users. A correspondence to the use probabilities is as illustrated in the symbols in FIG. 4A. FIG. 8A illustrates a state after completion of S501 of the disclosure information generating process (FIG. 5).

FIG. 8B illustrates a state where the anonymization group has been further generated after completion of S502 to S504. Two kinds of broken lines indicate anonymization groups. An anonymization group shown by a fine broken line 801b is an anonymization group of the layer in which a use probability is shown by Δ. An anonymization group shown by a coarse broken line 802b is an anonymization group of the layer in which a use probability is shown by ∘. Since the layer in which a use probability is shown by × does not disclose information, it is deleted from the diagram.

FIG. 8C illustrates a state where the anonymization information has been further generated after completion of S505, and illustrates an image of the information which is provided to the taxi service. A center of gravity and a radius are calculated for each anonymization group and generated as context information which is disclosed. The center of gravity, the radius, the probability of the group, the user ID of the user constituting the group, the use probability of the service of the user, and the like are disclosed to the taxi service for each anonymization group. As a probability of the group, a probability at which any one of the users executes the service is acquired by using the use probabilities of the services of the users constituting the group. The user ID is an ID closed to the taxi service. Therefore, the user ID cannot be used in combination with the data held by services other than the taxi service.

When the taxi service receives such information, a traveling route can be decided so that the taxi travels in an area shown by a broken line in FIG. 8C. In addition, by disclosing the user ID to the taxi service side, when the taxi service side has attribute information or the like associated with the user ID, a preparation or the like of the taxi can be performed on the basis of such information. For example, when signage is held in the taxi, an advertisement which is distributed to signage and is conformed with the user can be preliminarily downloaded and prepared, or the like.

However, items and forms of the information which is disclosed to the service are not limited to those mentioned above.

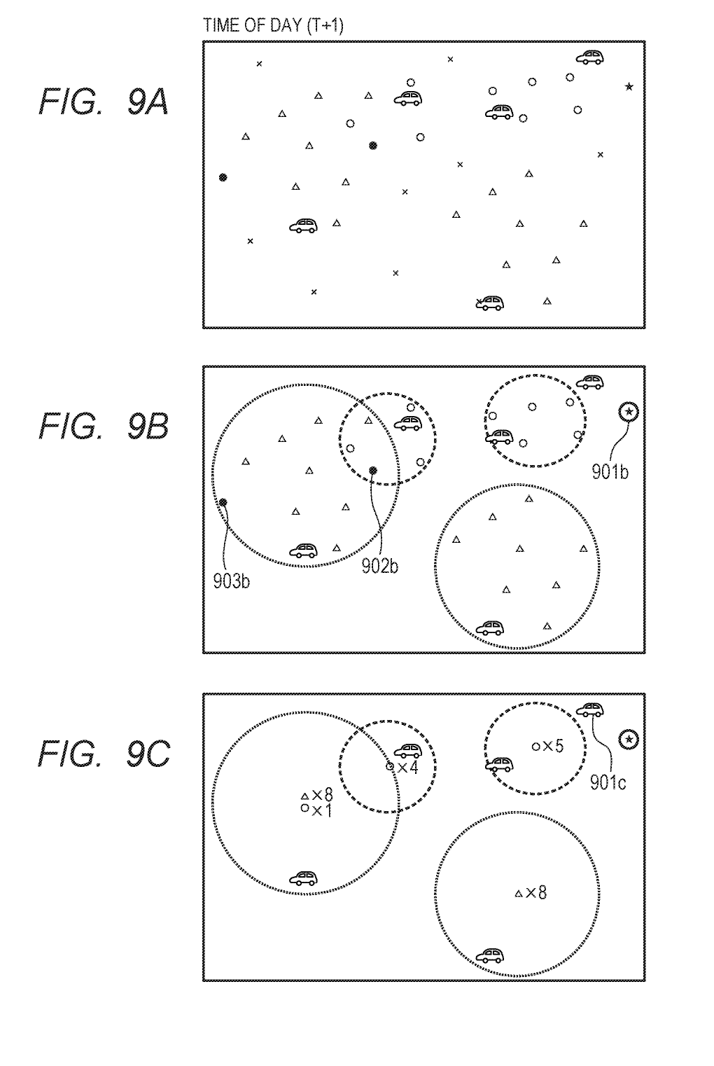

FIG. 9A is a diagram illustrating a distribution of the position information of the users at time of day (T+1) which is slightly advanced from time in FIG. 8A and use probabilities of the users. In FIG. 9A, black-painted symbols ( and ★) indicate portions that the use probabilities have been changed from time of day (T) and illustrate a state where the use probabilities are larger than those at time of day (T). At time T, since the traveling route has been determined so that the taxi travels the area surrounded by the broken line, the taxies of the number as many as the number of areas shown by the broken lines appear.

FIG. 9B illustrates a state of the anonymization groups in the state at time of day (T+1). As for users 901b and 902b in which the use probabilities are large, the anonymization groups are changed as compared with those at time of day (T). Therefore, a precision of information which is disclosed is high. On the other hand, as for a user 903b, the anonymization groups are not changed. This is because if the users and anonymization groups existing in the same layer are formed, an error becomes too large and, therefore, the groups are processed by the dismantling process of the limit error group so as to allocate the users into the anonymization groups of the lower layers.

FIG. 9C illustrates an image of information which is provided to the taxi service at time of day (T+1). The position information of the user 901b who requested a dispatch can be known from the taxi service. A taxi 901c which is in a standby state at a near location goes to meet the user, so that a waiting time of the user can be reduced.

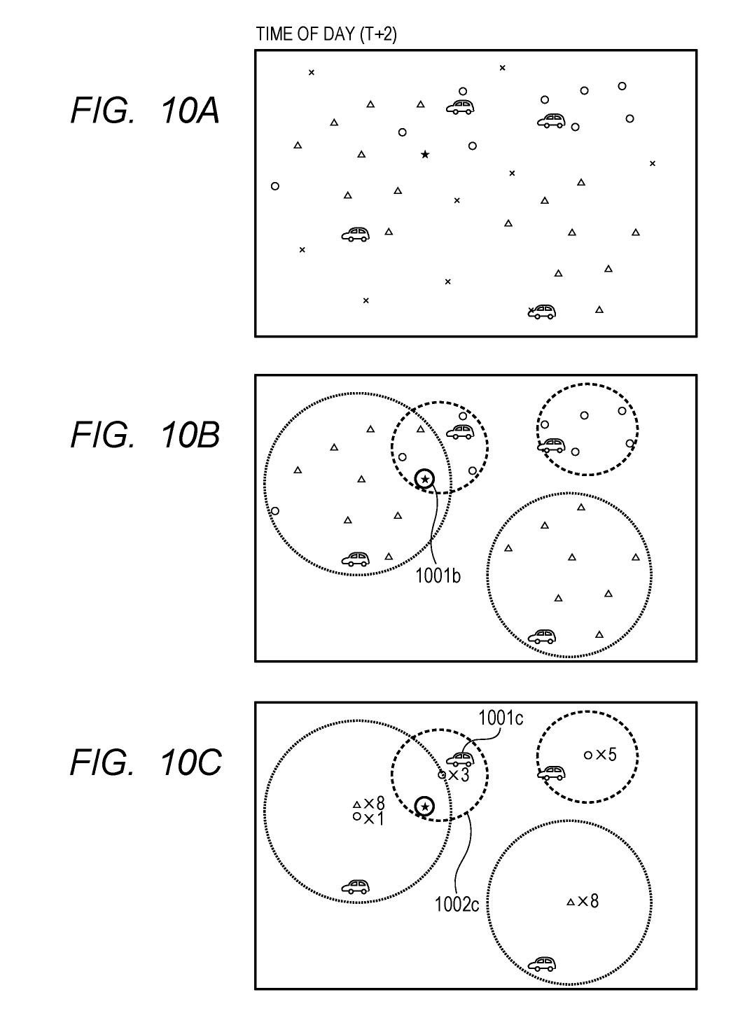

FIG. 10A illustrates a state where information similar to that in FIG. 9A is shown by advancing time to time of day (T+2). Since the taxi 901c and the user 901b went to a destination of the user, they have been removed from FIGS. 10A to 10C. In addition, the black-painted symbol (★) indicates a change portion of the use probability from time of day (T+1).

FIG. 10B illustrates a state of anonymization groups. A user 1001b forms the anonymization group by himself.

FIG. 10C illustrates an image of information which is provided to the taxi service. A taxi 1001c which was dispatched to a near location is allowed to go to meet the user 1001b. In addition, since a taxi which covers an area 1002c does not exist, another taxi is allowed to go to the area 1002c.

As mentioned above, the higher the use probability of the taxi is, a precision of the information rises. More specifically speaking, a precision of the position information rises. Therefore, in a state of the high use probability, a more personalized preparation is made. More specifically speaking, the taxi travels at a location near the user. Thus, such an effect that when the user requests a dispatch of a taxi, a waiting time is reduced is obtained.

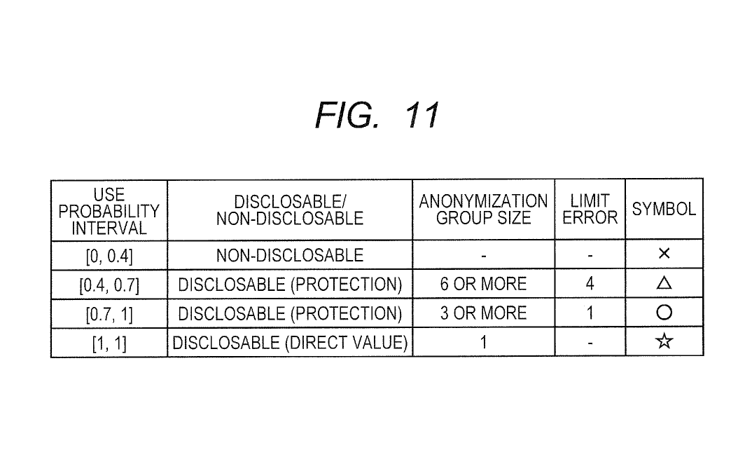

Subsequently, a case where there are a plurality of context information and attribute information or the like is included will be described as an example. In this instance, an example in which information of shoes which a customer (user of the PCA client) having a possibility of visit to a shop desires is shared to a shoes shop service will be described with reference to FIGS. 11 to 13B.

The shoes shop is a shop which sells shoes to the customers. When the customer visits the shop, he desires to see and try his desired shoes. Therefore, when he visits the shop, if there are no stocks of his desired shoes, since a salesperson goes to another neighboring shop in order to get them, such a situation that the user is kept waiting occurs. In order to solve such a problem, according to the shoes shop service, the shoes are prepared in accordance with information of the customer who visits the shop. By this method, such a situation that when the customer visits the shop, since there are no desired shoes, he is kept waiting is prevented.

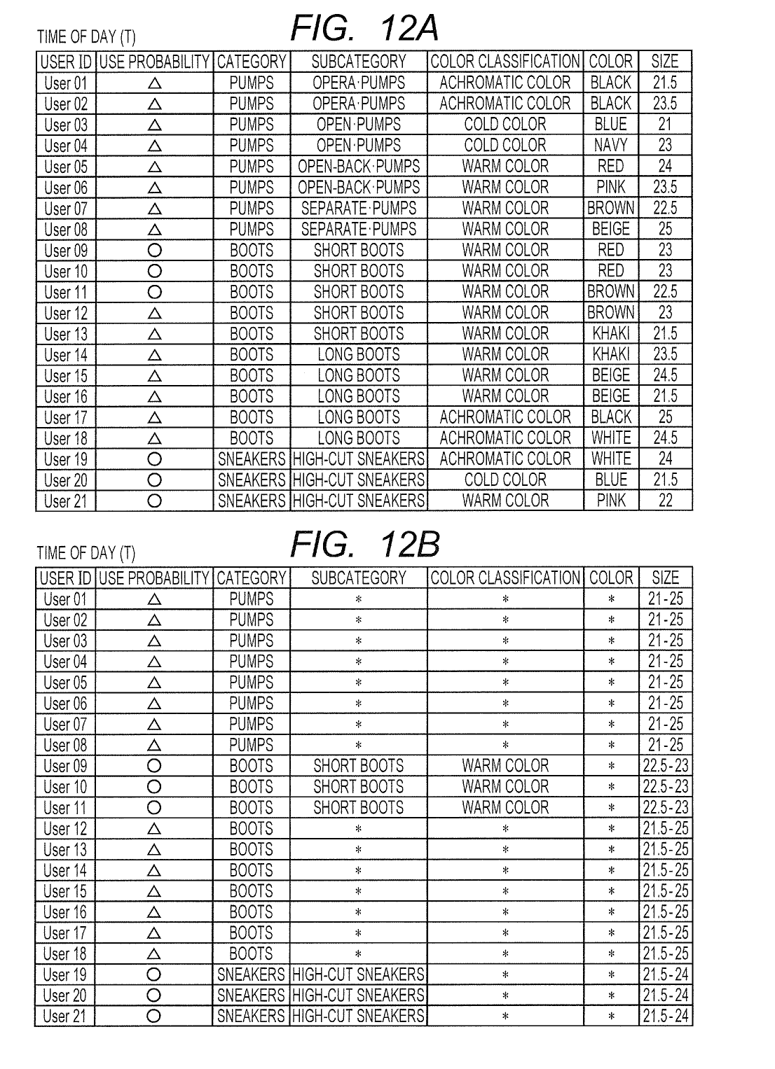

Context information before it is anonymized by the PCA server will be described with reference to FIG. 12A. Such information is information of the shoes which the user mainly wants to buy. Those information may be estimated from a habitual behavior of the user. For example, in the online shopping or the like, a list of things desired is preliminarily made. The context acquiring unit 306 may generate context information from the list of things desired. Or, the context acquiring unit 306 may acquire context information for a period of time during which the user visits several shoes shops. However, an acquiring method of the context information is not limited to them.

Each item of columns in FIG. 12A will be described.

The user ID is information to uniquely identify the user and if the service has already held the information about the user, the user ID is associated with such information and processed. For example, if the user is already a member or the like of the shop, since information such as age, sex, goods which were purchased before, and the like has already been accumulated in the shop, by associating the user ID with such information and processing, more various kinds of preparations can be made. For example, such a countermeasure that goods different from the goods purchased before by the user are prepared or the like can be made.

A use probability is a probability at which the user visits the shop, and is expressed by a symbol here. A correspondence between such a symbol and the use probability is as illustrated in FIG. 11.

A category and a subcategory are information about a kind of shoes. The category is a classification of an upper order and its lower classification is a subcategory.

A color classification and a color are information about a color of the shoes. The color classification is an upper order and its lower classification is the color.

A size is information about a size of shoes.

FIG. 12A illustrates context information at certain time of day (T). On the other hand, by executing the disclosure information generating process, the disclosure information generating unit 305 anonymizes “category, subcategory, color classification, color, size” and generates information of FIG. 12B. At this time, in the disclosure information generating process, parameters illustrated in FIG. 11 are used. Those parameters are almost identical to those illustrated in FIG. 4A. However, the limit error is changed in accordance with the context information which the user wants to anonymize. More specifically speaking, the limit error is set to the number of anonymized items (columns). That is, it is shown that to the data expressed by the symbol Δ of the use probability, it is desirable that the number of items which are anonymized is equal to or less than 4.

The disclosure information generating process shown in FIG. 5 will be described step by step hereinbelow.

In S501, the use probability calculating unit 307 estimates a use probability. For example, the use probability calculating unit 307 may preliminarily form a correspondence between a distance between the user and the shop and the use probability and set so as to allocate a small probability to the remote distance and to allocate a large probability to the nearest distance. For example, the use probability calculating unit 307 can realize such a process by setting a normal distribution or the like in which the shop is set to the center. Or, the use probability calculating unit 307 may allow the PCA server to form a traveling model between the spots by using the context information accumulated in the PCA server, for example, the use probability calculating unit 307 forms a movement probability, as a traveling model, between the spots on the basis of the position information collected from the users. The use probability calculating unit 307 acquires a movement probability between the spot where the user exists at present and the shoes shop on the basis of the traveling model. However, an estimating method of the use probability is not limited to them.

In S502, the use probability classifying unit 308 divides the users into layers for each use probability. In this example, the users are divided into layers of two use probabilities of Δ and ∘.

In S503, the use probability classifying unit 308 identifies the anonymization-target layer. According to FIG. 11, since the layers expressed by the symbols Δ and ∘ of the use probabilities are the targets, in FIG. 12A, all layers become the anonymization targets.

In S504, the anonymization classifying unit 309 executes the anonymization group generating process. First, the anonymization classifying unit 309 pays an attention only to the data of the symbol Δ of the use probability and repeats a process for dividing the users down to the minimum size which satisfies the condition of the anonymization group size. In this example, two groups of User 01 to User 08 and User 12 to User 12 are formed. Subsequently, the anonymization classifying unit 309 pays an attention to the data of the symbol ∘ of the use probability and executes a process. Thus, two groups of User 09 to User 11 and User 19 to User 21 are formed.

In S505, the anonymization information generating unit 310 generates disclosure information for each anonymization group. The anonymization information generating unit 310 processes each item for every four groups mentioned above. More specifically speaking, to “category, subcategory, color classification, color”, if all data in the group has the same value, the anonymization information generating unit 310 leaves such a value. If all data has different values, the unit 310 substitutes “⋆” for them. By such a method, an anonymization is performed so that the original values cannot be known. The anonymization information generating unit 310 replaces the size to a range of the data in the group, thereby disabling the size of each data to be known.

By the foregoing method, the context information for disclosure illustrated in FIG. 12B is generated. This information is disclosed to the shoes shop service. Thus, the shoes shop service collates with the stocks in the shop and, when the shoes written on the list do not exist in the stocks, it orders them from the neighboring shop.

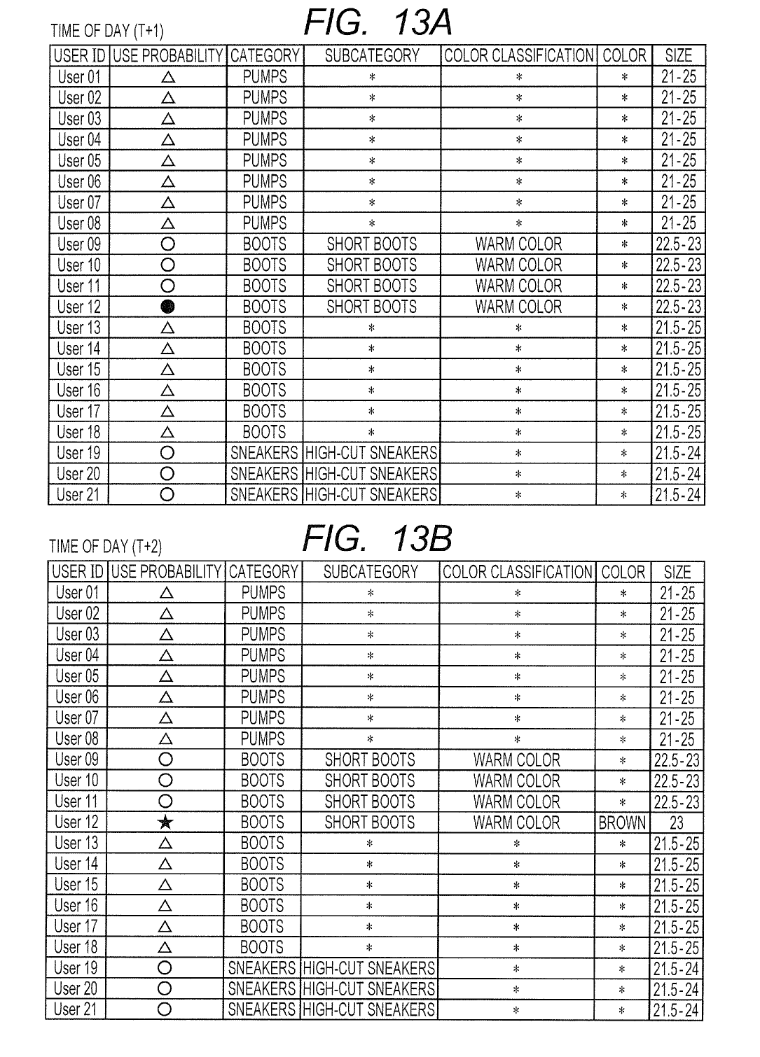

FIG. 13A illustrates the context information for disclosure at time of day (T+1) at which the time was advanced from the state illustrated in FIGS. 12A and 12B. Since the use probability of User 12 rises at time of day (T+1), the symbol of the use probability changes from Δ to ∘. In this instance, the symbol is painted in black for easy understanding.

The anonymization group generated in S504 changes as a result of the increase in use probability. More specifically speaking, in the data of the symbol Δ of the use probability, since User 12 dropped out of the group, the anonymization group changes to User 01 to User 08 and User 13 to User 18. Further, in the data of the symbol ∘ of the use probability, since User 12 was added, the anonymization group changes to User 09 to User 12 and User 19 to User 21.

The disclosure information is generated for each anonymization group. For example, as for the group of User 09 to User 12 including User 12, the color is replaced to ⋆ and the size is replaced to the interval of the data of the group.

Thus, in the disclosed context information of User 12, the subcategory and color classification which were not understood at time of day (T) because they were processed can be known.

FIG. 13B illustrates a state where the time of day was further advanced to T+2. Since the use probability of User 12 further rises at time of day (T+2), the symbol of the use probability changes from ∘ to ⋆. In this instance, the symbol is painted in black for easy understanding.

The anonymization group generated in S504 changes as a result of the increase in use probability. More specifically speaking, the anonymization group of the data of the symbol Δ of the use probability does not change. However, in the data of the symbol ∘ of the use probability, since User 12 dropped out, the anonymization group changes to User 09 to User 11 and User 19 to User 21. As for the data of ⋆ of the use probability, since it is a condition that the size of anonymization group is equal to 1, the anonymization group of only User 01 is generated.

The disclosure information is generated for each anonymization group. However, in the anonymization group including User 12, since the data exists only in User 12, its values are disclosed as they are. Therefore, in the disclosed context information of User 12, the color and size which were not known because they were processed at time of day (T+1) can be known.

As mentioned above, like User 12, as the use probability increases, a precision of the information of the user rises. More specifically speaking, the values of “category, subcategory, color classification, color” are known. An interval of “size” is narrowed. Thus, in a state of the high use probability, a more personalized preparation is made. More specifically speaking, the shoes adapted to the information disclosed by the user are prepared in the shop. Thus, such a situation that when the user visits the shop, his desired shoes do not exist in the stocks is avoided. The user can see and try the goods with a short waiting time.

In the example of the taxi service or shoes shop service, the case where the context information does not change but only the use probability changes has been mentioned. However, the context information also changes moment by moment. That is, in the case of the taxi service, as the user moves, the position information changes. According to the shoes shop service, information of the desired shoes also changes while the user visits a plurality of shops.

In this instance, although the example in which the use probability rises has been mentioned, there is also a case where the use probability decreases. When the use probability decreases, a precision of the information decreases. In the example of the taxi service, there is a case where coordinates of the center of gravity of the disclosure information differ largely from those of the position information of the user. In the example of the shoes shop service, such a situation that the values of “category, subcategory, color classification, color” are not known and an interval of “size” is widened occurs. Thus, the information of the user in which the use probability decreases is anonymized.

Even if the information which has been disclosed once is hidden by the anonymization, there can be a case where the service side has stored the disclosed information. However, since the context information changes moment by moment, it cannot follow a change after the disclosure.

Consequently, by changing the precision of the information in accordance with the probability at which the user uses the service, both of the anonymization and the service preparation can be accomplished.

Particularly, the disclosure information generating unit 305 constitutes the anonymization group and performs the anonymization for making the context information of the users of the same group coincident. By this method, the users in the group cannot be distinguished from other users. Thus, privacy can be protected.

In the embodiment, the context information is disclosed to the service side while including the user ID. However, such a user ID is a user ID closed to the service. Therefore, in order to associate with the data held by other services, it is necessary to make the data coincide with the context information disclosed in common and to unite the data. However, since the context information has been anonymized, the context information cannot be narrowed down to a predetermined number or more.

In the embodiment, by dividing the users into layers by the use probabilities, the anonymization is performed in the users in which the use probabilities are similar. Thus, such a situation that a precision of the information of the user of the high use probability is decreased in accordance with a request level of the anonymization of the user of the low use probability can be prevented. In addition, in the embodiment, the size of anonymization group is determined based on the use probabilities of the group. Therefore, the information after the anonymization can be made useful also to the service side. In addition, in the embodiment, the use probability of the group is set to the probability at which at least one of the users constituting the group uses the service. At this time, since a preparation to the provided information is used to any one of the users at the request probability, a possibility that the information becomes wasteful can be controlled in a manner of probability.

Further, in the embodiment, the limit error is predetermined for each layer of the use probability, the group exceeding the limit error is dismantled, and the users are allocated to another group. Thus, such a situation that the error becomes larger than the limit error can be suppressed for each use probability. Particularly, in the embodiment, when the users are allocated to another group, an allocation to a group of the layers lower than the layer to which the user belongs is also included. Consequently, such a situation that the error becomes larger than the limit error can be suppressed.

In the embodiment, the disclosure information is generated based on the use probabilities. However, the invention is not limited to the use probabilities but a request degree of the user to the service may be used. Specifically speaking, the invention is not limited to the continuous value between 0 and 1 like a probability but may be an unlimited continuous value such as 0 to 1 or a categorical value such as “high”, “middle”, and “low”, or the like. The request degree in the embodiment is not limited to them.

Although the request degree is acquired by estimating it by the system in the embodiment, the request degree which was input by the user may be used. Specifically speaking, a UI to input the request degree is displayed to the PCA client 101, thereby enabling the user to input a proper request degree. For example, the request degree acquired by presenting its value by five stages or the like and inputting it by a UI such as a slider or the like may be used. As for the stages, they may be generated so as to coincide with the number of layers by using the parameters at the time of generating the disclosure information as illustrated in FIG. 4A. Or, the request degree may be displayed by the coloring or the like and may be input via a button adapted to increase or decrease the request degree. Or, a use probability may be input or a continuous value or a categorical value for expressing the request degree may be input. Since there is also a case where the estimation makes a mistake, when the user strongly desires the service, the high request degree is input. Or, when the user hates that his own information is disclosed, the low request degree is actively input. By such a method, the information disclosure to which an intention of the user is reflected can be performed.

### Embodiment 2

In the foregoing embodiment, when the use probability is high, the information is disclosed to the service. However, even in the user in which it is estimated that the use probability is high, there is a case where he does not desire the disclosure of the information which is equal to or larger than a predetermined amount. Therefore, the disclosure information is generated so as to satisfy a disclosing condition designated by the user. In the present embodiment, a method of generating the disclosure information so as to satisfy an “anonymization request” as one of the disclosing conditions input by the user. Therefore, in the present embodiment, a method of generating the disclosure information so as to satisfy the anonymization request which was input by the user will be mentioned.

A function configuration of a system for generating information to be disclosed in the present embodiment will be described.

In the present embodiment, in addition to the configuration of the foregoing embodiment 1, an anonymization request inputting unit exists. In addition, the anonymization classifying unit 309 and the anonymization information generating unit 310 differ from those in the embodiment 1. A description will be made in order hereinbelow.

When the information of the user is disclosed, the anonymization request inputting unit of the embodiment inputs the anonymization condition which should be satisfied. For example, when the user information is disclosed, such a condition that a size of 3 or more persons is necessary as an anonymization group size is input. Or, such a condition that a size of 3 or more persons is necessary as an anonymization group size in a certain district or time zone may be input. Thus, when the user remains in a house or the like, the anonymization group can be increased so as not to clarify the location of the house.

Or, a condition of vagueness of the disclosure information may be designated. That is, when coordinates of the center and a radius are disclosed as disclosure information on the basis of the position information, a condition of the minimum value of the radius size may be designated as a condition. Or, when attribute information is disclosed, the minimum value of the number of anonymized items may be designated as a condition. Or, items which should be certainly anonymized or the like may be designated. The condition of vagueness of the disclosure information may be designated while including the conditions such as a district, time zone, and the like. For example, in a certain district, when the position information is disclosed, the minimum radius size is set to 100 m or more, or the like. Or, in a certain district, although the position information may be not disclosed or the like.

The anonymization request in the invention is not limited to them.

In the anonymization classifying unit of the present embodiment, the users are classified into groups for each layer acquired by the use probability classifying unit 308 on the basis of the similarity of the anonymization-target context information so as to satisfy the anonymization request. When the condition regarding the anonymization group size has been designated, the anonymization group is formed so as to satisfy the condition. Specifically speaking, in FIG. 5 in the embodiment 1, in a process between S501 and S502, the use probability is corrected so as to satisfy the anonymization request. For example, there is such a condition that the anonymization request is “anonymization group size is equal to 3 persons or more” and the user in which it is estimated that the use probability is equal to 1 in S501 exists, the use probability is corrected to 0.8 or the like as a value which is equal to or larger than 0.7 and is less than 1 on the basis of the parameters in FIG. 4A. If the anonymization request has a district, a time zone, and the like, the use probability is corrected only when those conditions are satisfied.

In the anonymization information generating unit of the present embodiment, the context information which is disclosed is generated so as to satisfy the anonymization request for each group acquired by the anonymization classifying unit 309. When the condition of vagueness of the disclosure information has been designated, the disclosure information is processed so as to satisfy the condition. Specifically speaking, just after S505 in FIG. 5 of the embodiment 1, when the disclosure information does not satisfy the anonymization request of the user, a process for realizing vagueness is further executed. For example, if the anonymization request is a condition of “radius of the position information is equal to 500 m or more”, when the radius of the disclosure information acquired for each user in S505 is equal to 100 m, the radius of the disclosure information of the user having the conditions is corrected to 500 m or the like, thereby generating the disclosure information.

Since the anonymization request can be designated for each user as mentioned above, it is possible to prevent that the information of a predetermined amount or more is disclosed.

### Embodiment 3

In the foregoing embodiment 1, the parameters (disclosure parameters) as illustrated in FIG. 4A are preliminarily held and the disclosure information according to them is generated. Therefore, the disclosure information is generated for each user on the basis of the estimated use probability of the system. However, the user who wants to actively disclose the information and receive a benefit of the service also exists in dependence on the users. In such a user, it is presumed that a request (preparation request) to a preparation of the service side is high. Also from the service side, there is information quality or the like necessary to satisfy the preparation request. It is also considered that the stages of the preparation of the service side or the like also differ in dependence on the services. Therefore, in the present embodiment, a method of generating the disclosure information so as to satisfy the “preparation request” as one of the disclosing conditions is shown. Particularly, a method of generating the disclosure information by using both of the preparation request which is required by the service side and the preparation request which is required by the user side will be described.

A function configuration of the system for generating the information which is disclosed in the present embodiment will be described.

In the present embodiment, in addition to the configuration of the foregoing embodiment 1, a user preparation request inputting unit, a service preparation request inputting unit, and a disclosure setting generating unit exist. In addition, the anonymization classifying unit 309 differs. A description will be sequentially made hereinbelow.

In the service preparation request inputting unit, an anonymization level and information quality are input. Specifically speaking, the anonymization level is a combination of disclosable/non-disclosable and the anonymization group size. For example, the combination of disclosable/non-disclosable and the anonymization group size as illustrated in FIG. 4A is designated. In this example, four levels are input. Although a description is made in such a form that the information illustrated in FIG. 4A is input, the number of anonymization levels may be increased, or the like. Further, the information quality is input in correspondence to the anonymization levels. For example, the information quality is a limit error. Or, the use probability of the group or the like may be used as information quality.

In addition, a use probability interval serving as an initial value may be input in correspondence to the anonymization level. Further, the contents of the preparation of the service side may be written as a comment to each anonymization level. Specifically speaking, in the case of the taxi service or the like, information regarding such a preparation that the taxi is dispatched to a location within a radius of 1000 m of the user is written. This information is used in the user preparation request inputting unit, which will be described hereinafter.

In the user preparation request inputting unit, a request regarding to which extent of the information the user wants to disclose is input. Specifically speaking, the number of anonymization persons corresponding to the use probabilities is input. For example, such a request that “when the use probability is equal to or larger than 0.7 and is less than 0.8, it is desired that the anonymization group size is set to 3 persons or more” or “when the use probability is equal to or larger than 0.8 and is equal to or less than 1, it is desired that the anonymization group size is set to one person” is input. Or, the limit error to the use probability is input. For example, if the disclosure information is position information, such a request that “when the use probability is equal to or larger than 0.7 and is less than 0.8, it is desired that the limit error is set to 200 m” is input.

The anonymization level may be presented from the system side and the foregoing information may be input in correspondence thereto. Specifically speaking, the user sets the use probability interval or the limit error to each anonymization level. At this time, the anonymization level to which the use probability interval is not made to correspond may exist. For example, in the case of the user who is tolerant to the information disclosure, such a process that the use probability interval is not made to correspond to such a level that the user feels that the anonymization is too strong, or the like can be performed.

When the anonymization level is presented from the system side, the comment of the preparation contents of the service side input by the service preparation request inputting unit may be also displayed together. Thus, the user can make the use probability interval correspond in consideration of both of the privacy protection and the service enjoyment.

In a disclosure parameter generating unit, on the basis of the information input by the service preparation request inputting unit and the user preparation request inputting unit, a disclosure parameter adapted to generate the disclosure information as illustrated in FIG. 4A is generated. In the foregoing embodiment, although the disclosure parameters are identical irrespective of the users, in the present embodiment, the disclosure parameter is generated for each user. Specifically speaking, the use probability interval acquired by the user preparation request inputting unit is made to correspond to the anonymization level input by the service preparation request inputting unit. In addition, the limit error input by the service preparation request inputting unit is overwritten by the limit error input by the user preparation request inputting unit.

When the anonymization level is too fine, the number of users who do not correspond the use probabilities is large and such a situation that the anonymizing process at each anonymization level becomes difficult is considered. Therefore, such a method whereby the use probabilities are output to the service providing side on the basis of the number of corresponding persons or the like and the correspondence of the anonymization levels is rounded and reformed may be provided.

In the anonymization classifying unit of the embodiment, the anonymization group is generated in accordance with the disclosure parameter of each user. Specifically speaking, in S502, the users are classified into layers in accordance with the use probability interval of the disclosure parameter of each user. In the users of the same layer, since the anonymization group sizes are equal, the subsequent processes are substantially the same as the processes to the limit error group dismantling process (S609 and flowchart of FIG. 7). In the limit error group dismantling process, since the limit errors differ for each user, the processes differ slightly. Specifically speaking, in S704, the user in which a difference between the current error and the limit error is large is preferentially selected. In S707 and S710, the processes are executed on the assumption that the limit errors of all users are satisfied, as a condition.

As mentioned above, the disclosure information is generated on the basis of the service and the preparation request required by the user. Particularly, by setting the service preparation request, the disclosure parameter to which the different service preparation stages and the necessary information quality are reflected can be generated for each service. In addition, by setting the service preparation request, the disclosure parameter to which the allowance to the disclosure of each user and activity to the service enjoyment are reflected can be generated.

In the foregoing present embodiment, the disclosure parameter is fixed to the user irrespective of the situation. However, the disclosure parameter may be changed according to the situation. Specifically speaking, in the service preparation request inputting unit and the user preparation request inputting unit, the conditions such as location, time zone, and the like may be input together. In the anonymization classifying unit, the disclosure parameters are switched and used according to the conditions.

That is, in the service preparation request inputting unit, a plurality of disclosure levels and a plurality of information qualities are set in accordance with the situation such as location, time zone, or the like. For example, in the taxi service or the like, in the area where the number of taxies is small, even if the anonymization levels are finely set, the system cannot cope with such a situation. Therefore, a method whereby the anonymization level is changed according to the area or the like is considered.

In the user preparation request inputting unit, the preparation request is designated by using the situation such as location, time zone, or the like as a condition. For example, such a form that the information is disclosed more on the basis of a condition such as “in a holiday” or the like. By this method, such an information disclosure that the service can be particularly actively received only in a holiday is performed. On the contrary, to a service regarding a business, such an information disclosure that if “8:00˜17:00 of a weekday” or the like is used as a condition, the service can be particularly actively received during the business is performed.

In the foregoing present embodiment, although a method of generating the disclosure information which satisfies the anonymization request shown in the embodiment 2 is not included, the system may be constructed so as to include it. Specifically speaking, in the disclosure parameter generating unit, the disclosure parameters may be generated by also using the condition of the anonymization group size of the anonymization request inputting unit. Or, although the anonymization group size is input from the anonymization request inputting unit, it may be input from the user preparation request inputting unit. In the anonymization request inputting unit, with respect to the condition of vagueness of the disclosure information, it is sufficient that the information which satisfies the condition is generated in the anonymization information generating unit as shown in the embodiment 2.

### Other Embodiments

Although the exemplary embodiments of the invention have been described in detail above, the present invention is not limited to the foregoing specific embodiments.

According to the processes of each of the foregoing embodiments, both of the privacy protection and the timing gap elimination can be attained. That is, when the probability at which the user uses the service is low, since the precision of the information is low, the privacy is protected. On the other hand, as the probability at which the user uses the service rises, the precision of the information increases. Therefore, the timing gap can be gradually reduced. Thus, a state where the timing gap is eliminated can be produced just before the user uses the service.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-052638, filed Mar. 16, 2016, and Japanese Patent Application No. 2017-011253, filed Jan. 25, 2017, which are hereby incorporated by reference herein in their entirety.

What is claimed is:

1. An information processing apparatus comprising:
an estimating unit configured to estimate use possibility of a service for each user;
a classifying unit configured to classify a plurality of users into groups on the basis of a similarity between the use possibility and context information of the plurality of users according to the service; and
a generating unit configured to generate disclosure information which is disclosed to a providing source side of the service for each of the groups on the basis of the context information of the users included in the group.

2. The information processing apparatus according to claim 1, further comprising an acquiring unit configured to acquire the context information of the users, and
wherein the estimating unit estimates the use possibility of the service for each user on the basis of the context information.

3. The information processing apparatus according to claim 1, wherein the classifying unit divides the plurality of users into layers on the basis of a similarity of the use possibility and classifies the plurality of users into groups for each of the divided layer on the basis of a similarity of the context information of the plurality of users belonging to the layer.

4. The information processing apparatus according to claim 3, wherein when the plurality of users are classified into the groups, the classifying unit classifies the plurality of users into the groups so that the use possibility of the group is equal to or larger than a set request probability.

5. The information processing apparatus according to claim 4, wherein the classifying unit sets the use possibility of the group to a probability at which at least one of the users included in the group uses the service, and classifies the plurality of users into the groups so that the use possibility of the group is equal to or larger than a set request probability.

6. The information processing apparatus according to claim 4, wherein the classifying unit approximates the use possibility of the group by a sum of the use possibility of the plurality of users included in the group, and classifies the plurality of users into the groups so that the use possibility of the group is equal to or larger than a set request probability.

7. The information processing apparatus according to claim 3, wherein the classifying unit classifies the plurality of users into the groups on the basis of the similarity in accordance with a size of the group set for each of the layers.

8. The information processing apparatus according to claim 4, wherein the classifying unit determines a size of the group on the basis of the use possibility of the group, and classifies the plurality of users into the groups on the basis of the similarity in accordance with the determined group size.

9. The information processing apparatus according to claim 3, wherein when the plurality of users are classified into the groups, if an error of the group is larger than a set error of the layer to which the group belongs among set errors which were set for the respective layers, the classifying unit moves the users included in the group to another group.

10. The information processing apparatus according to claim 9, wherein when an error of the group is larger than the set error of the layer, the classifying unit moves the users included in the group to a group in which a use possibility interval is smaller than that of the layer.

11. The information processing apparatus according to claim 4, wherein the generating unit generates the disclosure information in which the higher the use possibility of the group is, the more an anonymization is weakened for each of the groups on the basis of the context information of the users included in the group.

12. An information processing method which is executed by an information processing apparatus, comprising the steps of:
estimating use possibility of a service for each user;
classifying a plurality of users into groups on the basis of a similarity between the use possibility and context information of the plurality of users; and
generating disclosure information which is disclosed to a providing source side of the service for each of the groups on the basis of the context information of the users included in the group.

13. A non-transitory computer-readable storage medium storing a program for allowing a computer to function as each unit of an information processing apparatus comprising:
an estimating unit configured to estimate use possibility of a service for each user;
a classifying unit configured to classify a plurality of users into groups on the basis of a similarity between the use possibility and context information of the plurality of users according to the service; and
a generating unit configured to generate disclosure information which is disclosed to a providing source side of the service for each of the groups on the basis of the context information of the users included in the group.
